(19) United States
(12) Patent Application Publication
(10) Pub. No.: US 2001/0045252 A1
(43) Pub. Date: Nov. 29, 2001

(54) Bulk bag with detachable plastic liner and method of making same

(76) Inventor: Jean Andre Beard, Lafayette, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 09/777,161

(22) Filed: Feb. 5, 2001

Related U.S. Application Data
(60) Provisional application No. 60/190,617, filed on Mar. 20, 2000.

(51) Int. Cl. B32B 7/04

(52) U.S. Cl. 156/91

(57) ABSTRACT

A method of attaching a plastic or polyethylene liner to a fabric bag by first providing a plastic liner of the type used in fabric bulk bags, which may be open ended on both its upper and lower ends; rolling the upper end of the plastic liner at strategic points along the liner around a circular item, which will be termed a “button,” so that multiple layers of the liner are rolled around the “buttons”; next, tying off the multiple layers of liner along the undersurface of the button so as to allow the button to serve as an attachment point between the liner and the bulk bag; inserting the liner into the fabric bag; next, rolling up a portion of the outer fabric bag around the buttons, then tying off the fabric bag around each button, so that the attachment is provided between the liner and the outer fabric bag, at each of the buttons. There may further be provided a plurality of attachment points, such as loops sewn into the interior of the fabric bulk bag, or openings cut in the fabric of the outer bulk bag, so that each of the buttons around which the liner is wrapped and secured can be threaded either through the loop or through the opening of the bag.

### CROSS-REFERENCE TO RELATED APPLICATIONS

Priority of U.S. Provisional Patent Application Ser. No. 60/190,617, filed Mar. 20, 2000, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to bulk bags with liners and the method of assembling same. More particularly, the present invention relates to a fabric bulk bag having a plastic liner which is secured to the bag through detachable members which allow additional stresses to be placed on the liner without affecting the integrity of the liner. Further, this invention eliminates the need to introduce the liner into the bag manufacturing environment.

2. General Background of the Invention

In the art of transporting dry bulk materials, one of the most common type of transports is the fabric bulk bags which transport dry bulk in the one to two ton range. Often times the dry bulk which is carried by the fabric bags is very pure material which cannot be contaminated through contact with the fabric bag. Therefore, there is placed in the fabric bag a plastic or polyethylene type liner which line the entire bag so that when the bulk flows into the bag, it makes contact only with the interior surface of the plastic liner. The liner is then sealed off, and following transport, the bulk is then poured from the bottom of the bulk bag through the plastic liner, never making contact with any of the fabric of the outer bag.

One of the problems associated with bulk bag usage is the need to secure the liner to the fabric bag. This is needed to prevent the liner from sliding out of the bag during the discharge of product. There have been many methods used to secure the liner. Among these methods are the use of tape tabs (See patent no. (Custom Packaging)). These tabs can be sewn in or tied into the fabric bags. However, this has often required a specially made liner, which increases the cost of the application. Further, it requires either the liner to be installed and sewn into the bag within the standard production systems, or for the ties that will eventually hold the liner to be installed during the standard production of the bags. In both cases, the efficiency of the major production lines are undesirably deteriorated. Further, the application of the tape tab often creates identifiable corners of stress that lead to liner failure under stress.

Another method is to glue the liner into place (See U.S. Pat. No. 4,997,502). In this application, the low cost tube liner can be used and the glue and liner can be applied after the fabric bag completes production. However, the glues have shown themselves to deteriorate in cold weather leaving the bond greatly weakened and sometimes undependable. Further, in those applications where it is desirable to simply replace the liner and use the fabric bag again, a strong glue bond that has been unaffected by the cold can create problems with the removal of the glued liner.

### BRIEF SUMMARY OF THE INVENTION

What is provided is a method of attaching a plastic or polyethylene liner to a fabric bag by first providing a plastic liner of the type used in fabric bulk bags, which may be open ended on both its upper and lower ends; rolling the upper end of the plastic liner at strategic points along the liner around a circular item, which will be termed a “button,” so that multiple layers of the liner are rolled around the “buttons”; next, tying off the multiple layers of liner along the undersurface of the button so as to allow the button to serve as an attachment point between the liner and the bulk bag; inserting the plastic liner into the fabric bag; next, rolling up a portion of the outer fabric bag around the buttons, then tying off the fabric bag around each button, so that the attachment is provided between the liner and the outer fabric bag, at each of the buttons. There may further be provided a plurality of attachment points throughout the bad, such as strips sewn into the interior of the fabric bulk bag, or openings cut in the fabric of the outer bulk bag, so that each of the buttons around which the liner is wrapped and secured can be threaded either through a buttonhole in each of the strips secured to the fabric bag.

Therefore, it is a principal object of the present invention to provide a plastic liner secured to an outer fabric bag which would allow bulk to be easily poured into the bag and the bag would be closed at its upper end;

It is a further object of the present invention to provide a method of attaching the liner to the fabric bag through the rolling of the liner around a series of “buttons” as the points of attachment between the liner and the bag which provides significantly stronger attachment points so as to eliminate the tearing of the liner which currently occurs with stitched or tape tab attachment liners;

It is a further object of the present invention to provide a method of attachment between a plastic liner and a fabric bulk bag so as to avoid any contact between the interior of the liner and the fabric bag;

It is a further object of the present invention to provide a strong, yet uncontaminated connection between a plastic liner and an outer fabric bag, wherein after use the liner can be detached from the fabric bag, and the bag can be reused with other liners.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIGS. 1-8 illustrate the preferred embodiment of the steps in the method of assembling the apparatus of the present invention.

FIGS. 9A and 9B illustrate isolated views of the attachment between the liner and the outer fabric bag;

FIGS. 10 illustrates an overall cross-sectional view of the liner secured to an outer fabric bag;

FIGS. 11 and 12 illustrate isolated exterior views of the liner secured to the outer fabric bag;

FIGS. 13 through 16 illustrate alternative views of the attachment between the inner liner and outer fabric bag; and

FIGS. 17 through 19 illustrate alternative shaped buttons used in the present invention.

### DETAILED DESCRIPTION OF THE PREFERRED EMBODIMENT

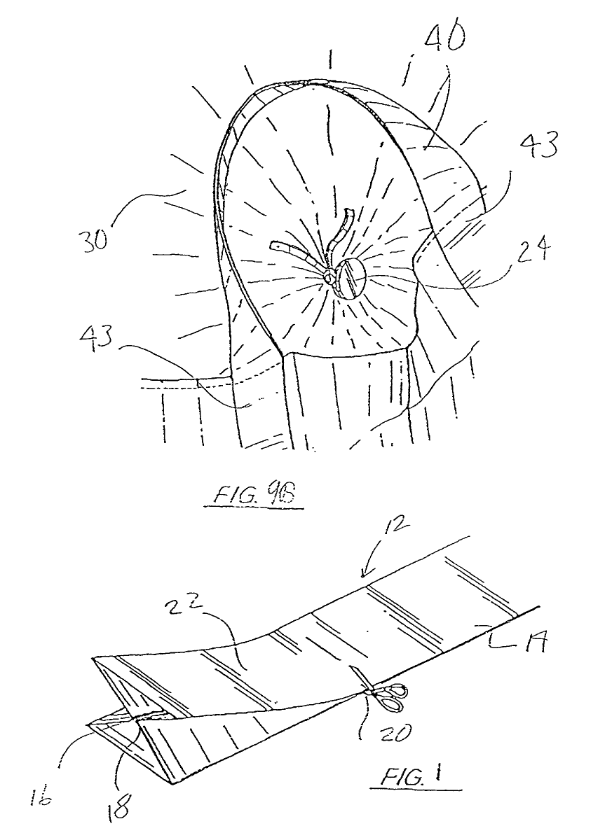

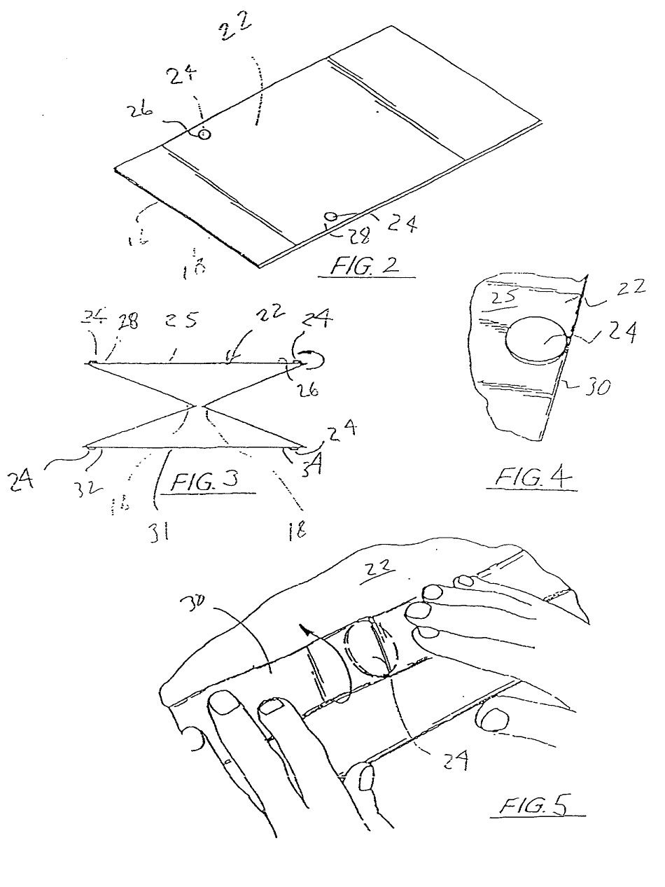

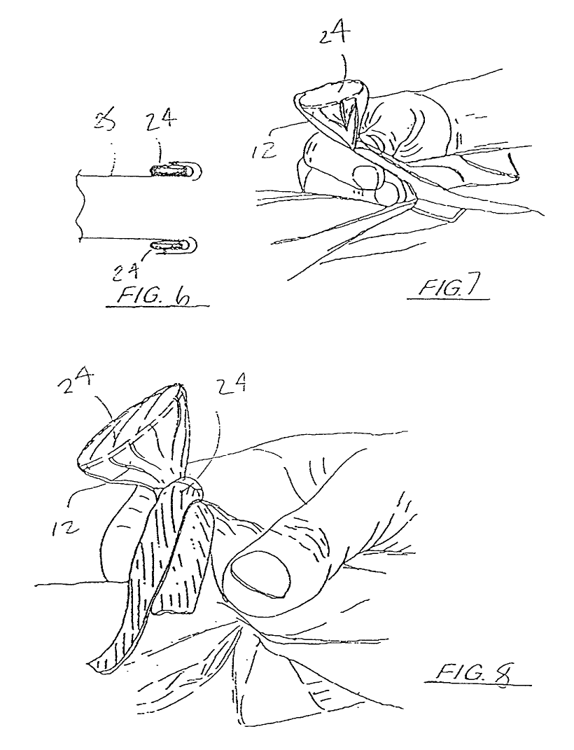

FIGS. 1 through 19 illustrate the steps in the method of fabricating the apparatus of the present invention and the present invention itself. Turning first to FIG. 1, there is illustrated a length of plastic liner 12, which is of the type available in a continuous tube 14, with the tube configured with half of the width of the tube 14 folded inward at 16, 18, so that the tube can be transported and store as half its width. As seen in FIG. 1, a length of tube 14 is then cut off the roll at point 20, to provide a section 22 of tube 14, the length being sufficient to be placed within a fabric bulk bag (as seen in FIG. 10), as will be explained further. Next, reference is made to FIG. 2, where the section 22 is laid flat, with the sections 16, 18 continued to be folded as seen in FIG. 3. A button 24 is then laid upon the edge of the upper face 25 of section 22 at points 26, 28 as seen in FIGS. 2, 4 and 6. At this time, the edge 30 of the tube is then rolled over the button one or more times as seen in FIG. 5, the result illustrated in FIGS. 7 and 8. The button 24 is encased in multiple layers of the plastic liner 12, and the plastic liner 12 is then gathered by hand as seen in FIG. 7, and wrapped around button 24, as seen in FIG. 8, where it is tied off with a tie 27 below button 24, again as shown in FIG. 8.

Returning now to FIGS. 2 and 3, this process of folding the liner one or more times around button 24, the liner gathered behind the button, then tied off by tie 27, is repeated for point 28, on the upper face 25 of liner 12, and as seen in FIG. 3, two more buttons 24 are positioned at points 32, 34 on the underside 31 of liner 12, and attached at those points through the method described above. Therefore, there would be a series of four buttons 24 wherein the liner 12 has been wrapped around and tied off, the four points being spaced apart evenly at that place on the liner which would be approximately at the four upper corners of the fabric bag in the area of the four lifting loops 40, after the liner is fed through the fabric bag.

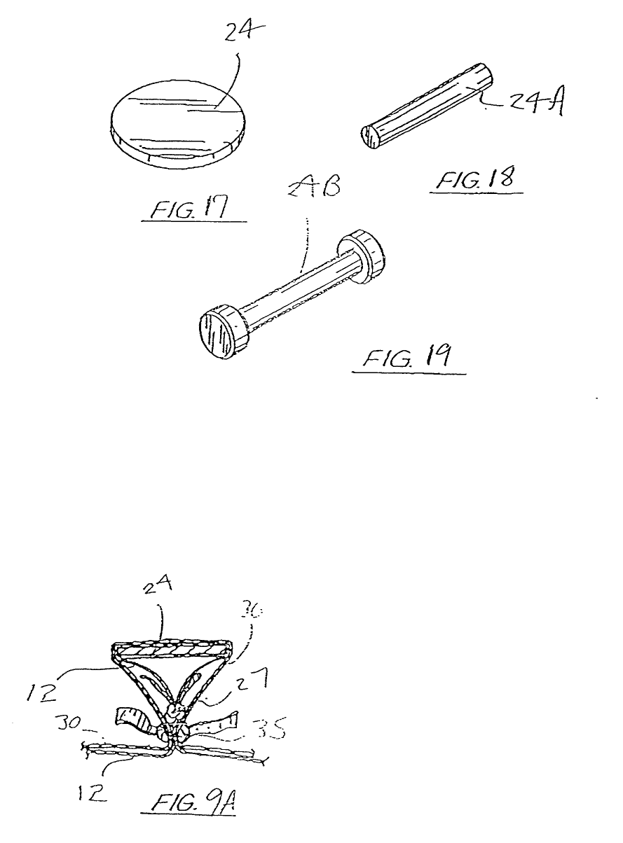

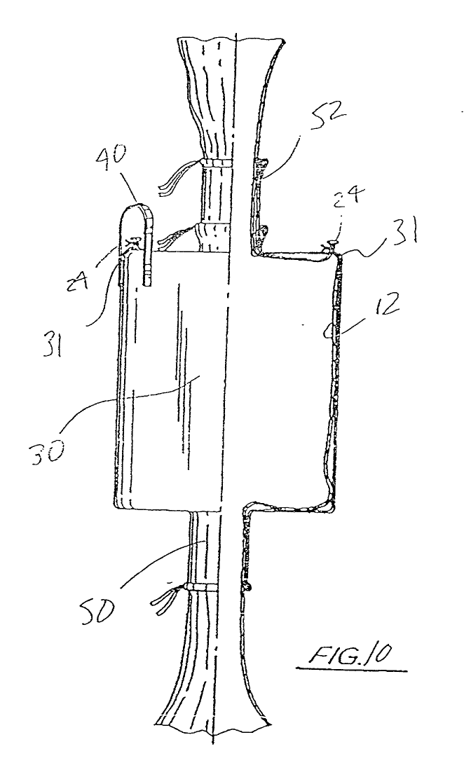

At this point, following the positioning of the four buttons 24 secured to liner 12, the section 22 of liner 12 is then fed through the upper opening in a fabric bag 30, so that the buttons 24 are positioned in the area of the shoulder 31 of the fabric bag, and the lower end of the liner 12 extends out of the lower spout of the fabric bag, as seen in FIG. 10. When the liner is in this position, each button 24 is then pushed up against a portion of the fabric bag, as seen in FIG. 9B, generally in the area between the ends 43 of the lifting loop 40. The fabric bag 30 is then wrapped around the button 24 encased in liner 12, and the fabric bag 30 is then tied off around the underside of the button 24, with tie 35, as seen in FIG. 9A. In that figure button 24 is illustrated being encased in multiple layers of plastic liner 12, and tied off with tie 27. There is then illustrated the liner encased button 24 again encased in a layer of fabric bag 30 and tied off a second time with tie 35. The result is illustrated in FIG. 9B, seen from the outside of fabric bag 30. This is repeated at each corner of each lifting loop 40, as seen in FIGS. 11 and 12. After each have been tied off, the result is the liner being secured at the four upper connection points at the lifting loops, so that the liner 12 is firmly secured to the bag 30, and there has been no contact between the interior of the liner 12 and the fabric bag 30, thus avoiding any chance of contamination of the liner. FIG. 10 illustrates a complete bag having the interior liner 12 secured to the bag at each shoulder 31, which would be prepared to be closed off on the bottom spout 50 and to receive product within the bag through the upper spout 52.

This means of attachment is important to the ease of refurbishing the outer bag. Since the liner 12 has no permanent attachment, such as gluing or stitching, once the product has been removed from the interior of the bag, the ties 35 between the outer bag and the liner can be removed, and the liner 12 pulled from the bag 30, the buttons 24 retrieved, the liner 12 discarded, and the outer fabric bag 30 is ready for reuse.

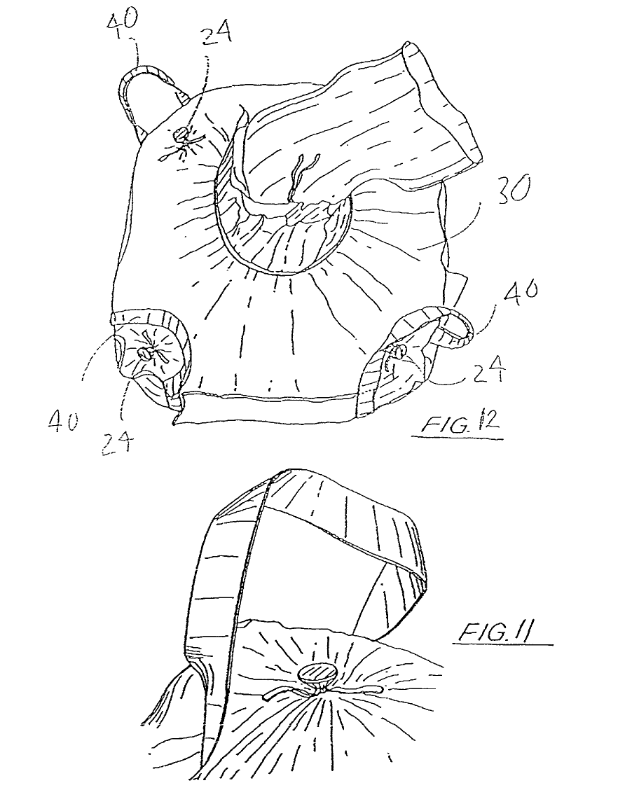

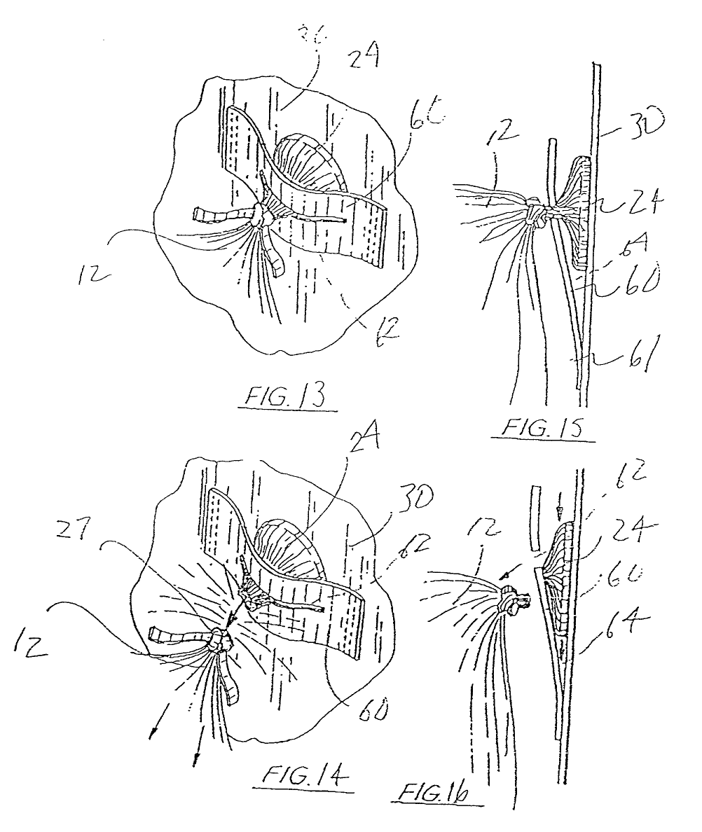

FIGS. 13 through 16 illustrate alternative means for attaching the liner 12 to the fabric bag 30 other than through the means described above. As seen in FIG. 13, rather than secure the liner-wrapped button to the fabric bag 30 with a second tie, there is illustrated a strip 60 sewn into the interior of the outer bag, the strip having a cut or buttonhole 62 through the strip 60 so that the button 24 can be threaded through the cut 62, like a button through a buttonhole. Such a strip 60 would be secured at each inner point of the fabric bag 30 at the area of the four lifting loops 40. FIGS. 14 through 16 illustrate a means for keeping the button 24 within the strip, should the button be pulled away from the liner. As see in FIG. 14, the button 24 has popped off the liner 12. As seen in FIGS. 15 and 16, the bottom edge 61 of strip 60 is sewn to the outer bag 30 to define a pocket 64 into which the button 24 would remain, rather than fall into the bottom of the bag, and contaminate the product being poured from the bag.

FIGS. 17 through 19 illustrate the preferred shapes that the buttons 24 may take. FIG. 17 illustrates the round “coin” button that has been discussed through the various figures. However, the button may be a cylinder 24A as seen in FIG. 18, or the button may be shaped like a barbell 2B as illustrated in FIG. 19. This shapes have been shown in experiments to provide for great attachment strength between the liner and the fabric bag, and result in fewer failures of the plastic liner when the liner is wrapped around the buttons for attachment points.

The foregoing embodiments are presented by way of example only; the scope of the present invention is to be limited only by the following claims.

1. A fabric bulk bag in combination with a removable plastic liner, comprising:
a) a fabric bulk bag of the type having sidewalls, a top wall, a bottom wall and openings in at least the top or bottom walls of the bag;
b) a plastic liner insertable into the fabric bulk bag, the liner open-ended on its upper and lower ends or sealed at one or both ends;
c) means for removably securing the plastic liner to the bag, comprising a member positioned on the outer face of the liner and secured thereto; and
d)means for removably securing the liner-encased member to the outer bag after the liner has been placed within the outer bag.

2. The combination in claim 1, wherein the means for securing the plastic liner to the fabric bag comprises a button positioned on the liner and wrapped by the liner, and tied off to be removably secured to the liner.

3. The combination in claim 1, wherein the members are secured to the liner in four points around the circumference of the liner.

4. The combination in claim 1, wherein the liner-encased members are tied off onto the outer bag after the liner has been positioned within the fabric bag.

5. The combination in claim 1, wherein the means for attaching the liner to the fabric bag may comprise a strip secured to the interior of the outer bag for buttoning the members to the fabric bag.

6. A method of attaching a removable plastic liner to an outer fabric bulk bag, comprising the following steps:
a) providing a fabric bulk bag of the type having sidewalls, a top wall, a bottom wall and openings in at least the top and bottom walls of the bag;
b) providing a plastic liner, the liner open-ended or sealed on its upper and/or lower ends;
c) wrapping the plastic liner around a button member multiple times;
d) tying off the liner below the button member to maintain the liner wrapped around the button member;
e) applying steps c and d to multiple button members around a circumference of the liner;
f) inserting the liner with the multiple button members into the fabric bag;
g) securing the multiple button members to the interior of the fabric bag so that the liner is maintained within the fabric bag when product is released out of the liner.

7. The method in claim 6, wherein the step of securing the multiple button members to the interior of the fabric bag comprises wrapping the fabric bag around the button and tying of f the button so that the button is maintained secured onto the fabric bag.

8. The method in claim 6, wherein the step of securing the multiple button members to the interior of the fabric bag comprises securing the button members to strips within the interior of the fabric bag.

9. A method of securing a plastic liner to an outer fabric bulk bag, comprising the following steps:
a) providing a plurality of flat members, of a certain diameter;
b) wrapping a part of the plastic liner around each of the members, so that at least a single layer of plastic liner is wrapped around each member;
c) securing the plastic liner tightly around each member, for defining a “button” feature;
d) inserting the liner with the plurality of flat members into the fabric bag;
e) wrapping the fabric bag around each of the flat members and tying off each of the flat members to maintain the members secured to the fabric bag.

10. The method in claim 9, wherein the members may be secured to the outer fabric bag through a plurality of strips formed in the inner surface of the fabric bag.

11. The method in claim 9, wherein the members wrapped in the plastic liner may be unsecured from the outer bag and the plastic liner discarded without damaging the outer fabric bag.

12. The method in claim 9, wherein the step of wrapping the plastic liner around each of the members with at least a single layer of plastic defines a stronger connection point between the liner and the fabric bag than conventional gluing of the liner to the bag.
